(19) United States
(12) Patent Application Publication
(10) Pub. No.: US 2020/0372217 A1
(43) Pub. Date: Nov. 26, 2020

(54) METHOD AND APPARATUS FOR PROCESSING LANGUAGE BASED ON TRAINED NETWORK MODEL

(71) Applicant: Samsung Electronics Co., Ltd., Suwon-si (KR)

(72) Inventors: Analle Jamal ABUAMMAR, Amman (JO); Bashar Bassam TALAFHA, Amman (JO); Ruba Waleed JAIKAT, Amman (JO); Muhy Eddin ZATER, Amman (JO)

(21) Appl. No.: 15/929,824

(22) Filed: May 22, 2020

(30) Foreign Application Priority Data
May 22, 2019 (KR) 10-2019-0060219

(51) Int. Cl. G06F 40/289; G06F 16/2457; G06K 9/62; G06N 3/08

(52) U.S. Cl. CPC G06F 40/289; G06N 3/08; G06K 9/6215; G06F 16/24578

(57) ABSTRACT

The disclosure relates to an artificial intelligence (AI) system utilizing a machine learning algorithm like deep learning and applications thereof. A method of processing a language based on a trained network model includes obtaining a source sentence including a plurality of words. The method also includes determining a plurality of paraphrased sentences including paraphrased words for each of the plurality of words constituting the source sentence and levels of similarity between the plurality of paraphrased sentences and the source sentence. The method further includes obtaining a pre-set number of paraphrased sentences from among the plurality of paraphrased sentences based on the similarity levels.

### CROSS-REFERENCE TO RELATED APPLICATION

This application is based on and claims priority under 35 U.S.C. § 119 to Korean Patent Application No. 10-2019-0060219, filed on May 22, 2019, in the Korean Intellectual Property Office, the disclosure of which is incorporated by reference herein in its entirety.

### BACKGROUND

### 1. Field

The disclosure relates to a method of processing a language based on a trained network model, and more particularly, to a method, an apparatus, and a server for generating a plurality of paraphrased sentences corresponding to a source sentence by using a trained network model.

The disclosure also relates to an artificial intelligence (AI) system and application technology thereof for simulating functions like recognition and judgment of the human brain regarding language processing by using a machine learning algorithm such as deep learning.

### 2. Description of Related Art

An artificial intelligence (AI) system is a computer system that implements human-level intelligence, and, unlike existing rule-based smart systems, it is a system that learns, judges, and becomes smart by itself. The recognition rate of an AI system is improved and the AI system becomes capable of understanding a user's taste more accurately as the AI system is repeatedly used. Therefore, existing rule-based smart systems are being gradually replaced by deep learning-based AI systems.

AI technology includes machine learning (deep learning) and elementary technology utilizing machine learning. Machine learning is an algorithm technology for autonomously classifying/learning characteristics of input data. The element technologies are technologies that utilize machine learning algorithms like deep learning to simulate functions of a human brain like cognition and judgment and include technological fields for linguistic understanding, visual understanding, reasoning/prediction, knowledge representation, motion control, etc.

Various fields to which AI technology is applied are as follows. Linguistic understanding is a technique for recognizing, applying, and processing human languages/characters and includes natural language processing, machine translation, a dialogue system, a query response, speech recognition, and/or synthesis. Visual understanding is a technique for recognizing and processing objects in a manner similar to that of human vision and includes object recognition, object tracking, image searching, human recognition, scene understanding, space understanding, and image enhancement. Reasoning/prediction is a technique to determine information for logical reasoning and prediction and includes knowledge/probability-based reasoning, optimization prediction, preference-based planning, and recommendation. Knowledge representation is a technique for automating human experience information into knowledge data and includes knowledge building (data generation/categorization) and knowledge management (data utilization). Motion control is a technique for controlling autonomous driving of a vehicle and a motion of a robot and includes motion control (navigation, collision avoidance, driving), manipulation control (behavior control), etc.

Neural machine translation (NMT) is a translation technology capable of providing a translation result by understanding an entire sentence by using an engine to which machine learning is applied and reflecting words, order, meanings, and meaning difference in the context of the sentence. However, the existing NMT has problems like mistranslation of rare languages or rare terms that lack resources or providing sentence translation results on a sentence-to-sentence basis without considering paragraphs or contexts, and thus improvement of translation efficiency is limited.

Therefore, there is a need for research into language processing techniques to resolve the above or other problems or to at least provide a useful alternative.

### SUMMARY

The disclosure provides a method, an apparatus, and a system for determining a plurality of paraphrased sentences corresponding to a source sentence by using a trained network model.

The disclosure also provides a method, an apparatus, and a system for determining a plurality of translated sentences by translating a source sentence into a language different from the source sentence by using a trained network model.

The disclosure also provides a computer program product including a computer readable recording medium having recorded thereon a program for executing the methods on a computer. The technical problems to be solved are not limited to the above technical problems, and other technical problems may exist.

Additional aspects will be set forth in part in the description which follows and, in part, will be apparent from the description, or may be learned by practice of the presented embodiments of the disclosure.

According to an embodiment of the disclosure, there is provided a method of processing a language based on a trained network model, the method including: obtaining a source sentence; obtaining a plurality of words constituting the source sentence; determining a plurality of paraphrased sentences including paraphrased words for each of the plurality of words constituting the source sentence and similarity levels between the plurality of paraphrased sentences and the source sentence; and obtaining a pre-set number of paraphrased sentences from among the plurality of paraphrased sentences based on the similarity levels.

The method may further include: receiving an image, wherein the obtaining of the source sentence may include recognizing a text included in the received image; and obtaining the source sentence from the recognized text.

The trained network model may include a sequence-to-sequence model that includes an encoder and a decoder to which context vectors are applied as inputs and outputs, respectively, and the similarity level may be determined based on a probability that the paraphrased words determined by the decoder and the words of the source sentence coincide with each other.

The method may further include performing at least one of a tokenizing process and a normalizing process with respect to the plurality of words constituting the source sentence, wherein context vectors representing words obtained as a result of performing the above processes may be obtained.

The obtaining of the pre-set number of paraphrased sentences may include: determining ranks of the plurality of paraphrased sentences based on the similarity levels, the respective numbers of words constituting the plurality of paraphrased sentences, and the respective lengths of the plurality of paraphrased sentences; and selecting the pre-set number of paraphrased sentences from among the plurality of paraphrased sentences based on determined ranks.

In the determining of the ranks of the plurality of paraphrased sentences, the ranks of the plurality of paraphrased sentences may be determined by using beam search.

The plurality of paraphrased sentences may include paraphrased sentences written in a language different from the obtained source sentence.

The plurality of paraphrased sentences may include a plurality of paraphrased sentences written in the same language as the source sentence and paraphrased sentences written in a language different from the obtained source sentence.

According to another embodiment of the disclosure, there is provided a device for processing a language based on a trained network model, the device including a memory configured to store one or more instructions; and at least one processor configured to execute the one or more instructions stored in the memory, wherein the at least one processor executes the one or more instructions to obtain a source sentence, to obtain a plurality of words constituting the source sentence, to determine a plurality of paraphrased sentences including paraphrased words for each of the plurality of words constituting the source sentence and similarity levels between the plurality of paraphrased sentences and the source sentence, and to obtain a pre-set number of paraphrased sentences from among the plurality of paraphrased sentences based on the similarity levels.

According to another embodiment of the disclosure, there is provided a computer readable recording medium having recorded thereon a program for executing the above method on a computer.

According to another embodiment of the disclosure, there is provided a trained network model-based language processing system for executing the above method implemented as one or more computer programs at one or more locations on a computer.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a schematic diagram showing an example for determining a plurality of paraphrased sentences for a source sentence, according to an embodiment of the disclosure;

FIG. 2 illustrates a flowchart of a method for determining a plurality of paraphrased sentences for a source sentence, according to an embodiment of the disclosure;

FIG. 3 illustrates a block diagram showing a trained network model using a sequence-to-sequence encoder-decoder model, according to an embodiment of the disclosure;

FIG. 4 illustrates a flowchart of a method for word embedding a plurality of words, according to an embodiment of the disclosure;

FIG. 5 illustrates a flowchart of a method for performing pre-processing processes, such as a tokenizing process and a normalizing process for a plurality of paraphrased words, according to an embodiment of the disclosure;

FIG. 6 illustrates a block diagram showing a trained network model including a sequence-to-sequence encoder-decoder attention model, according to an embodiment of the disclosure;

FIG. 7 illustrates a flowchart of a method for selecting an arbitrary number of top sentences from among a plurality of paraphrased sentences, according to an embodiment of the disclosure;

FIG. 8 illustrates a flowchart of a method of unsupervised access for increasing data for a source sentence, according to an embodiment of the disclosure;

FIG. 9A illustrates a diagram showing an example of a system for outputting a plurality of paraphrased sentences of a source sentence on a device, according to an embodiment of the disclosure;

FIG. 9B illustrates a diagram showing an example of a system for outputting a plurality of paraphrased sentences written in a language different from the source sentence on a device, according to an embodiment of the disclosure;

FIG. 10 illustrates a diagram showing an example of a method for extracting a text from an image and outputting a plurality of paraphrased sentences, according to an embodiment of the disclosure;

FIG. 11 illustrates a diagram showing a configuration of a server according to an embodiment of the disclosure;

FIG. 12 illustrates a block diagram showing a structure of a processor according to an embodiment of the disclosure;

FIG. 13 illustrates a diagram showing an example in which a device and a server learn and recognize data by operating in conjunction with each other, according to an embodiment of the disclosure;

FIG. 14 illustrates a diagram for describing a processor according to an embodiment of the disclosure;

FIG. 15 illustrates a block diagram showing a data learner according to an embodiment of the disclosure; and

FIG. 16 illustrates a block diagram showing a data recognizer according to an embodiment of the disclosure.

### DETAILED DESCRIPTION

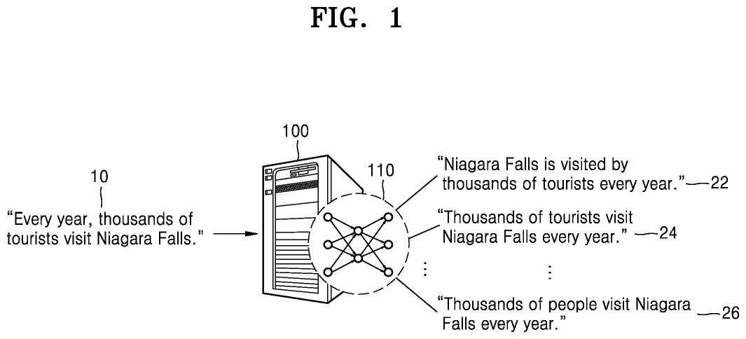

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The terms used in this specification will be briefly described, and the disclosure will be described in detail.

With respect to the terms in the various embodiments of the disclosure, the general terms which are currently and widely used are selected in consideration of functions of structural elements in the various embodiments of the present disclosure. However, meanings of the terms may be changed according to intention, a judicial precedent, appearance of a new technology, and the like. In addition, in certain cases, a term which is not commonly used may be selected. In such a case, the meaning of the term will be described in detail at the corresponding part in the description of the disclosure. Therefore, the terms used in the various embodiments of the disclosure should be defined based on the meanings of the terms and the descriptions provided herein.

While such terms as “first,” “second,” etc., may be used to describe various components, such components must not be limited to the above terms. The above terms are used only to distinguish one component from another. For example, without leaving the scope of the specifications, a first component may be named as a second component and similarly, the second component may be named as the first component. Descriptions shall be understood to include any and all combinations of one or more of the associated listed items when the items are described by using the conjunctive term “˜ or ˜,” “˜ and/or ˜,” or the like, whereas descriptions shall be understood to include independent items only when the items are described by using the term “˜ or one of ˜.”

Throughout the disclosure, the expression “at least one of a, b or c” indicates only a, only b, only c, both a and b, both a and c, both b and c, all of a, b, and c, or variations thereof.

Furthermore, the term “unit” used in the specification means a software component or a hardware component like FPGA or ASIC, and “unit” performed a certain role. However, the term “unit” is not meant to be limited to software or hardware. A “unit” may be configured to be on an addressable storage medium and may be configured to play back one or more processors. Therefore, for example, the “units” may include components, such as software components, object-oriented software components, class components, and task components, processes, functions, properties, procedures, subroutines, program code segments, drivers, firmware, micro codes, circuits, data, databases, data structures, tables, arrays, and variables. Components and functions provided in the “units” may be combined to smaller numbers of components and “units” or may be further divided into larger numbers of components and “units”.

Throughout the specification, when a part is “connected” to another part, this includes not only “directly connected” but also “electrically connected” with another element in between. In addition, unless explicitly described to the contrary, the word “comprise” and variations such as “comprises” or “comprising” will be understood to imply the inclusion of stated elements but not the exclusion of any other elements.

The word “exemplary” is used herein to mean “used as an example or illustration.” Any embodiment described as “exemplary” in the disclosure should not necessarily be construed as preferred or construed as having an advantage over other embodiments of the disclosure.

Also, a trained network model in present disclosure is an artificial intelligence algorithm and may be a learning model trained by using at least one of machine learning, neural networks, genes, deep learning, and classification algorithms.

A sequence-to-sequence model is a combination of two recurrent neural networks (RNN) models to obtain an output sequence by inputting an input sequence and may include at least one of a sequence-to-sequence encoder-decoder model, a sequence-to-sequence attention model, and a sequence-to-sequence encoder-decoder attention. A sequence-to-sequence model including an encoder and a decoder is a trained network model in which the encoder outputs an input sequence as a context vector and the decoder obtains an output sequence by receiving the context vector as an input.

An attention mechanism is a technique that trains a trained network model by paying more attention to input words related to a word to be predicted at that point and may be a technique for training a trained network model by using at least one of dot-product attention, context-based attention, global attention, local attention, and MLP attention.

Hereinafter, exemplary embodiments of the disclosure will be described in detail with reference to the accompanying drawings so that those skilled in the art may easily implement the disclosure. The disclosure may, however, be embodied in many different forms and should not be construed as limited to the embodiments set forth herein. In order to clearly illustrate the disclosure, parts not related to the description are omitted, and like parts are denoted by like reference numerals throughout the specification.

Hereinafter, the disclosure will be described in detail with reference to the accompanying drawings.

FIG. 1 illustrates a schematic diagram showing an example for determining a plurality of paraphrased sentences for a source sentence according to an embodiment of the disclosure.

Referring to FIG. 1, a device for determining a plurality of paraphrased sentences may determine a plurality of paraphrased sentences from a source sentence by using a trained network model 110 provided in a server 100. The trained network model 110 may be a set of algorithms for determining paraphrased sentences of source sentences. Also, the trained network model 110 may be implemented as software or an engine for executing a set of algorithms. The trained network model 110 implemented as software or an engine may be executed by a processor in the server 100 or a processor in a device.

According to an embodiment of the disclosure, the server 100 may obtain a source sentence from an external device and determine a plurality of paraphrased sentences identical to or having similar meanings as the obtained source sentence by using the trained network model 110. Also, the server 100 may transmit all of the plurality of determined paraphrased sentences or at least some of the plurality of determined paraphrased sentences based on a pre-set number.

According to an embodiment of the disclosure, the server 100 may determine a pre-set number of paraphrased sentences according to similarity with a source sentence. The similarity may be determined based on a probability that paraphrased words obtained by a decoder constituting the trained network model 110 match words constituting the source sentence.

For example, when the server 100 obtains a source sentence “Every year, thousands of tourists visit Niagara Falls” (hereinafter referred to as a sentence 110), the trained network model 110 may determine a plurality of paraphrased sentences including “Niagara Falls is visited by thousands of tourists of tourists every year.” (hereinafter referred to as a sentence 2a, 22), “Thousands of tourists visit Niagara Falls every year.” (hereinafter referred to as a sentence 2b, 24)”, and “Thousands of people visit Niagara Falls every year.” (hereinafter referred to as a sentence 2c 26). The sentence 2a 22 corresponds to a paraphrased sentence obtained by changing the sentence 110 from passive to active, the sentence 2b 24 corresponds to a paraphrased sentence obtained by changing the sequence of words of the sentence 110, and the sentence 2c 26 corresponds to a paraphrased sentence, which has the same word sequence as the sentence 2b 24 and is obtained by replacing the word ‘tourists’ with a paraphrased word ‘people’. Therefore, the plurality of paraphrased sentences may include sentences obtained by changing the sequence of words of a source sentence, changing the sentence structure of the source sentence, or replacing the words of the source sentence with paraphrased words, and the plurality of paraphrased sentences may include a sentence identical to the source sentence.

The server 100 may be connected with a device through a network. The server 100 may obtain a source sentence from the device through the network. In this case, the network may include a local area network (LAN), a wide area network (WAN), a value added network (VAN), a mobile radio communication network, a satellite communication network, and a combination thereof. However, it is merely an example. The network refers to a data communication network in a comprehensive sense that allows a device and the server 100 to communicate with each other smoothly, and may include a wired internet, a wireless internet, and a mobile wireless communication network.

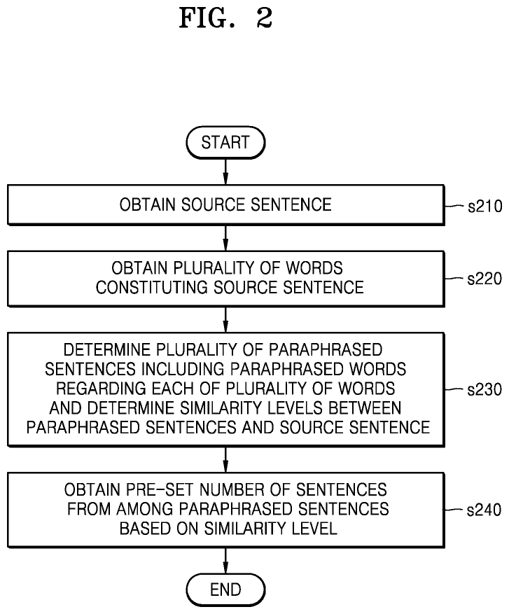

FIG. 2 illustrates a flowchart of a method by which a server obtains a plurality of paraphrased sentences for a source sentence by using a trained network model, according to an embodiment of the disclosure.

In operation S210, the server may obtain a source sentence. According to an embodiment of the disclosure, the server may obtain a source sentence from a memory in the server or receive a source sentence from a device, but the method by which the server obtains a source sentence is not limited thereto.

In operation S220, the server may obtain a plurality of words in the source sentence. According to an embodiment of the disclosure, the server may obtain a plurality of words constituting the source sentence from the source sentence by using a trained network model. Here, the trained network model may include one or more neural networks. For example, the server may obtain the words “Every”, “year”, “thousands”, “of”, “tourists”, “visit”, “Niagara”, and “Falls” for a sentence 1.

Also, the server may obtain an arbitrary vector representing the words obtained in operation S220. The arbitrary vector may be represented by at least one of letters, numbers, and symbols to represent information of respective words constituting the source sentence. Elements of an arbitrary vector may each have a value corresponding to at least one of letters, numbers, and symbols through word embedding. Also, the arbitrary vector may be an embedding vector obtained by word-embedding the source sentence.

For example, at least one of similar letters, numbers, and symbols may be allocated to Korea and Seoul, the United States and Washington, Spain and Madrid, Italy and Rome, Germany and Berlin, Japan and Tokyo, and China and Beijing.

In operation S230, the server may determine a plurality of paraphrased sentences including paraphrased words of each of a plurality of words by using a trained network model and determine similarity levels between paraphrased sentences and source sentences, respectively. Similarity levels are information indicating the degree of similarity between an arbitrary vector of a plurality of words in a source sentence and an arbitrary vector of a plurality of words in a plurality of paraphrased sentences, and, for example, may be determined by using various techniques, such as a mean square error, an Euclidean distance, and a Kullback-Leibler divergence.

When an arbitrary paraphrased sentence is similar to a source sentence for a sentence length, a probability value, parts of speech of words constituting sentences, and honorific titles, a server according to an embodiment of the disclosure may determine a similarity level between the source sentence and the arbitrary paraphrased sentence to be higher than a similarity level between the source sentence and a paraphrased sentence without such similarities.

In operation S240, the server may obtain a pre-set number of sentences from among generated paraphrased sentences based on a determined similarity level. For example, the server may obtain K paraphrased sentences (where K is a pre-set number of sentences) in the descending order of similarity levels from among N generated paraphrased sentences based on similarity levels. Also, the server may transmit the obtained K paraphrased sentences a user device that requested the same. The transmitted K paraphrased sentences may be displayed on the user device.

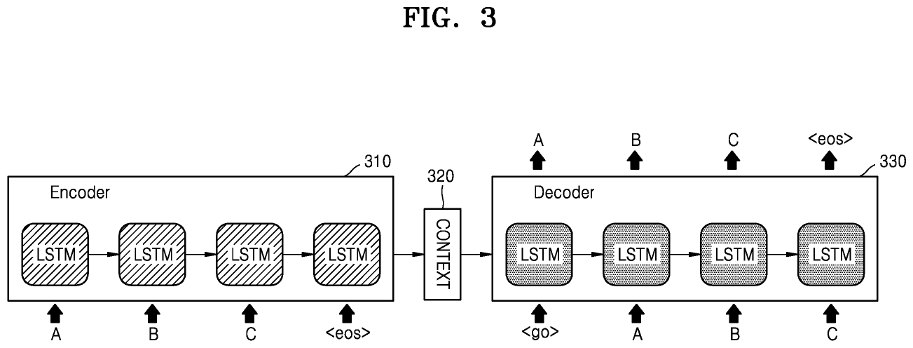

FIG. 3 illustrates a block diagram showing a trained network model using a sequence-to-sequence encoder-decoder model according to an embodiment of the disclosure.

Referring to FIG. 3, a trained network model according to an embodiment of the disclosure may include an encoder 310 and a decoder 330 for a specific language. The encoder 310 and the decoder 330 may each include a neural network. Furthermore, the encoder 310 and the decoder 330 may each include one or more LSTM layers.

The encoder 310 may encode and convert a sentence expressed in a corresponding language into a context vector 320 corresponding to a source sentence. A sentence may be language data in the form of text. For example, the encoder 310 may extract abstracted information (e.g., a feature vector) from a source sentence through encoding and generate the context vector 320 mapped to the abstracted information.

Also, the decoder 330 may decode the context vector 320 and convert the context vector 320 into a plurality of paraphrased sentences corresponding to the source sentence. For example, the decoder 330 may extract abstracted information (e.g., feature vector) from the context vector 320 through decoding, and generate a plurality of paraphrased sentences expressed in a corresponding language mapped to the abstracted information.

For example, when the server inputs sequences A, B, C, and a termination code <eos> indicating the end of a sentence to the encoder 310, the encoder 310 may generates the context vector 320 regarding the sequences A, B, and C. When the server inputs the context vector 320 regarding the sequence A, B, and C, and a code <go> indicating the start of a sentence, and the sequences A, B, and C to the decoder 330, the decoder 330 may decode the context vector 320 and the code <go> and output the sequences A, B, and C and the termination code <eos>.

According to an embodiment of the disclosure, a plurality of paraphrased sentences may include at least one of a sentence same as a source sentence, a plurality of paraphrased sentences written in the same language as the source sentence, and a plurality of paraphrased sentences written in a language different from the source sentence. Also, the plurality of paraphrased sentences may include both a plurality of paraphrased sentences written in the same language as the source sentence and a plurality of paraphrased sentences written in a language different from the source sentence. Also, the trained network model may more effectively increase paraphrased sentences corresponding to source sentences in each language.

For example, when the server obtains a sentence 1 as a source sentence, the server may determine sentences 2a, 2b, and 2c in English, which is the same language as the source sentence, and simultaneously determine sentences “ [symbol] [symbol] [symbol] ”, “ [symbol] [symbol] [symbol] ”, and “ [symbol] [symbol] [symbol] ” in Korean, which is a language different from the source sentence. Therefore, the server may increase data for two languages simultaneously.

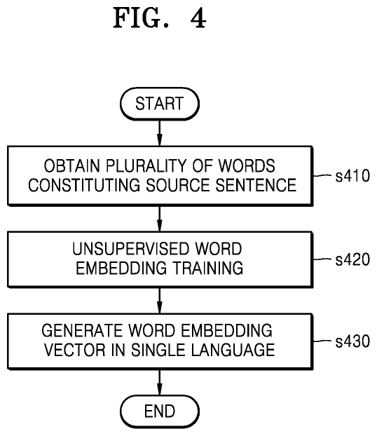

FIG. 4 illustrates a flowchart of a process for word embedding a plurality of words according to an embodiment of the disclosure.

The word embedding refers to representation of words in the form of a multi-dimensional vector in which each dimension has a real value in a multi-dimensional vector space. One or more of various attributes may correspond to a specific dimension of a vector, and a specific attribute may be represented in one or more dimensions. A vector generated as a result of word embedding may be placed as a point in a multi-dimensional embedding vector space by applying a multi-dimensional scaling technique (MDS) to a matrix of distances between words.

In operation S410, the server may obtain a plurality of words constituting a source sentence. A server according to an embodiment of the disclosure may obtain the source sentence from a memory in the server or receive the source sentence from a device. The server according to an embodiment of the disclosure may obtain a plurality of words from the source sentence by using a trained network model. Here, the trained network model may include one or more neural networks.

In operation S420, the server may input the plurality of words constituting the obtained source sentence into the one or more neural networks. The one or more neural networks may perform unsupervised word embedding on the plurality of words constituting the obtained source sentence.

In operation S430, the neural network may generate an embedding vector from the plurality of words as a result of the unsupervised word embedding. The word embedding refers to representation of words in the form of a multi-dimensional vector in which each dimension has a real value in a multi-dimensional vector space. One or more of various attributes may correspond to a specific dimension of a vector, and a specific attribute may be represented in one or more dimensions. Thus, paraphrased words may be located close to each other on each dimension.

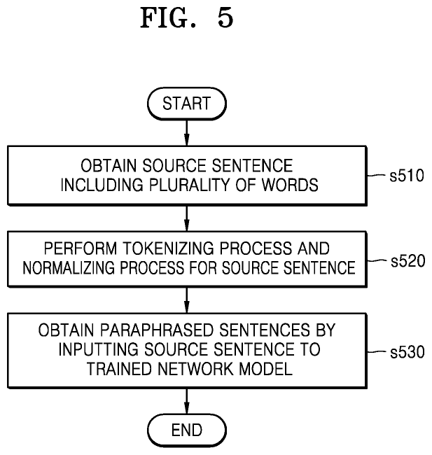

FIG. 5 illustrates a flowchart of a method for performing pre-processing processes, such as a tokenizing process and a normalizing process for a plurality of paraphrased words according to an embodiment of the disclosure.

The tokenizing process refers to breaking up a text string into one or more tokens to facilitate analysis of a sentence. A token is a piece of a text string having a meaning. A token may be a word, a sentence, a morpheme, a syllable, or a text corresponding to a pre-set number of characters, but is not limited thereto.

In operation S510, a server may obtain a source sentence including a plurality of words. Operation S510 may correspond to operation S210 described above with reference to FIG. 2.

In operation S520, the server may perform at least one of a tokenizing process or a normalization process as a pre-processing process for the source sentence. The server may improve the efficiency of analysis by reducing the number of words to be input to a trained network model through the pre-processing process. Also, the server may obtain an arbitrary vector representing one or more words obtained as a result of performing the pre-processing process.

In operation S530, a server 100 may obtain a plurality of paraphrased sentences for the source sentence by inputting words, which are tokenized and normalized through the pre-processing process of operation S530, to the trained network model. A method of determining a plurality of paraphrased sentences from a source sentence may correspond to the method described above with reference to FIG. 1.

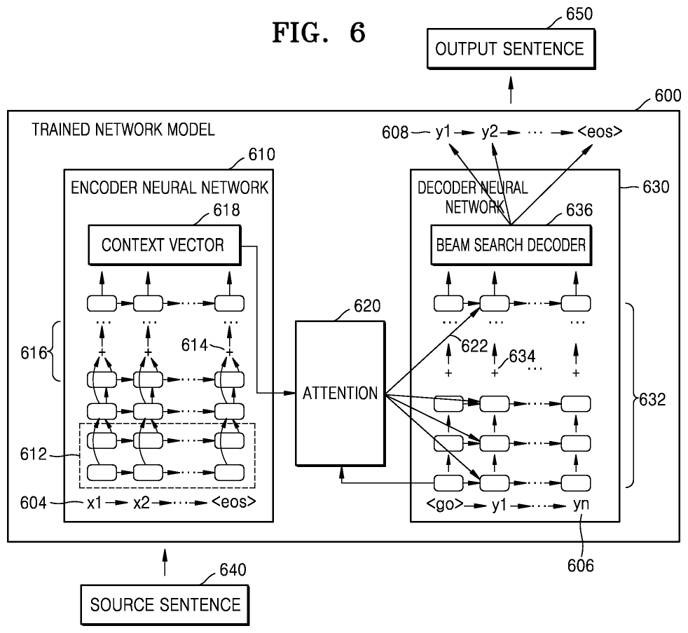

FIG. 6 illustrates a block diagram showing a trained network model 600 including a sequence-to-sequence encoder-decoder attention model according to an embodiment of the disclosure.

Referring to FIG. 6, the trained network model 600 may include one neural network or a plurality of trained network models 600 including at least one of an encoder neural network 610, an attention model 620, and a decoder neural network 630. Each neural network may include one or more long/short-term memory (LSTM) layers 612, 616, and 632. The encoder neural network 610 may include at least one of a forward LSTM layer, a backward LSTM layer, and a bidirectional LSTM layer 612. Also, the encoder neural network 610 may include at least one of a stack 616 of a plurality of LSTM layers and an adder 614. The decoder neural network 630 may include at least one of one or more LSTM layers 632, an adder 634, and a beam search decoder 636.

According to an embodiment of the disclosure, the trained network model 600 may receive a source sentence 640 and output an output sentence 650. The encoder neural network 610 may obtain an input token sequence 604 obtained by tokenizing the source sentence 640 as an input. Also, the encoder neural network 610 may generate a context vector 618 corresponding to the source sentence 640 by passing the input token sequence 604 through one or more layers. The generated context vector 618 may be input to the attention model 620.

According to an embodiment of the disclosure, the attention model 620 may receive the context vector 618 from the encoder neural network 610 and calculate a weight value 622 based on the context vector 618. The attention model 620 may transmit a weight value 622 to the decoder neural network 630.

According to an embodiment of the disclosure, the decoder neural network 630 may receive a preceding output token sequence 606 of a final output token sequence 608 from a server. The preceding output token sequence 606 may be the same as the input token sequence 604 or may correspond to a paraphrased word sequence of the input token sequence 604, but is not limited thereto. The decoder neural network 630 may pass the preceding output token sequence 606 through one or more layers. Also, the decoder neural network 630 may add a sequence passed through layers by using the adder 634. A final sequence may be transmitted to the beam search decoder 636. The beam search decoder 636 may determine the final output token sequence 608 through a beam search. The trained network model 600 may determine the output sentence 650 using the determined final output token sequence 608.

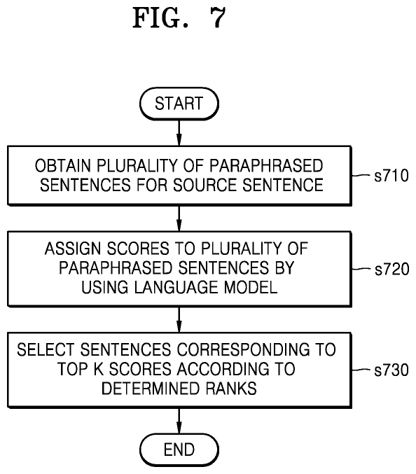

FIG. 7 illustrates a flowchart of a method of selecting a pre-set number of sentences from among a plurality of paraphrased sentences according to an embodiment of the disclosure.

In operation S710, a server may obtain a plurality of paraphrased sentences for a source sentence. Operation S710 may correspond to operation S530 described above with reference to FIG. 5.

In operation S720, the server may assign a score to each of the plurality of paraphrased sentences corresponding to the source sentence by using a language model. The server may determine ranks by assigning scores to the plurality of paraphrased sentences based on the number of words constituting each of the plurality of paraphrased sentences and the length of each of the plurality of paraphrased sentences. The language model may refer to a model that calculates the probability of a sentence by using a trained network model. The language model may be used for at least one of machine translation, typo correction, and speech recognition, but is not limited thereto.

For example, when the language model is used for machine translation and the trained network model translates the sentence 1 into Korean, the language model may determine a higher rank for a natural active sentence “ [symbol] [symbol] [symbol] [symbol] ” than an unnatural passive sentence “ [symbol] [symbol] [symbol] ”.

Also, when the language model is used for typo correction, the language model may determine a higher rank for the sentence 1 than a sentence “Every year, thousands of tourists visits Niagara Falls.” with a grammatical error.

Also, when the language model is used for speech recognition, the language model may determine a higher rank for a sentence “I receive the mail” than a sentence of “I receive the male”.

In operation S730, the trained network model may select top K sentences according to determined ranks from among a plurality of paraphrased sentences to which scores are assigned. K may be a pre-set number in the trained network model, may be a number determined by a user input, a number received from a user device, or a number determined to be suitable by the trained network model, but is not limited thereto.

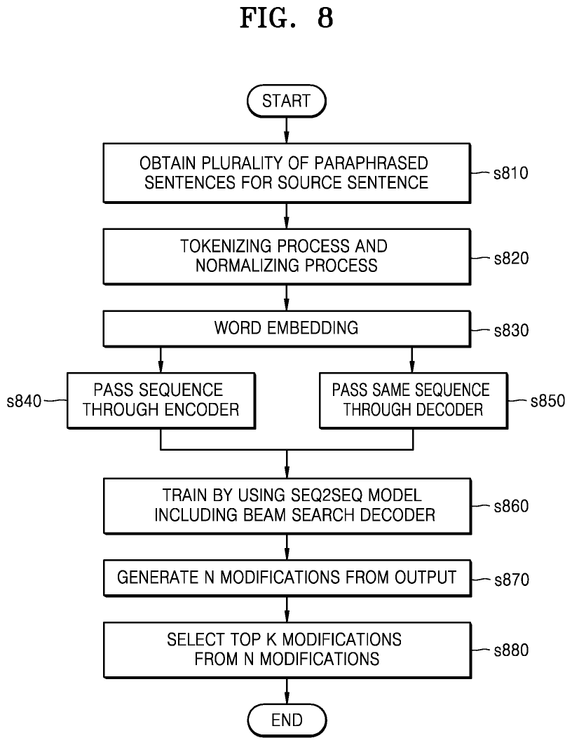

FIG. 8 illustrates a flowchart of a method of an unsupervised access for increasing data for a source sentence according to an embodiment of the disclosure.

In operation S810, a server may obtain a source sentence including a plurality of words. Operation S810 may correspond to operation S210 described above with reference to FIG. 2.

In operation S820, the server may perform a tokenizing process and a normalization process as pre-processing processes. Operation S820 may correspond to operation S520 described above with reference to FIG. 5.

In operation S830, the server may perform a word embedding process. Operation S830 may correspond to the word embedding process described above with reference to FIG. 4. The server may generate one or more sequences as a result of performing the word embedding process. The server may transmit the one or more generated sequences to an encoder neural network and a decoder neural network.

In operations S840 and S850, the server may generate a context vector for each sequence by using the one or more generated sequences by using the encoder neural network. Also, the server may generate one or more output sequences by inputting one or more sequences and context vectors by using the decoder neural network. The one or more sequence input by using the decoder neural network may include, but is not limited to, a sequence identical to one or more input sequences of an encoder or a paraphrased word sequence for the one or more input sequences of the encoder.

In operation S860, the server may train the trained network model by using one or more output sequences. The trained network model may include at least one of an encoder neural network, an attention model, a decoder neural network, and a beam search decoder.

In operation S870, the server may generate N modified sentences from the source sentence. N may be the maximum number of sentences that may be generated within the trained network model, a pre-set number in the trained network model, a number received from a user device, or a number determined to be suitable by the trained network model, but is not limited thereto.

In operation S880, the server may select modifications of top K sentences from among the N modified sentences by using the beam search decoder. Operation S890 may correspond to operation S730 described above with reference to FIG. 7.

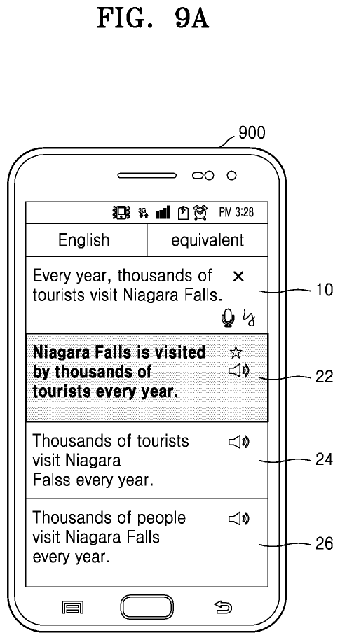

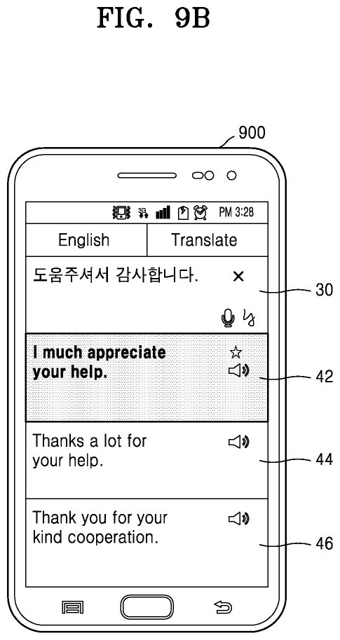

FIG. 9A illustrates a diagram showing an example of a device for outputting a plurality of paraphrased sentences written in the same language as a source sentence, according to an embodiment of the disclosure.

In an embodiment of the disclosure, a user of a device 900 may communicate with a server via a network to obtain a plurality of paraphrased sentences of a source sentence. For example, as the user inputs a source sentence to the device 900, the device 900 may transmit a request for generating a plurality of paraphrased sentences written in the same language as the source sentence to the server via a network. The server may transmit a plurality of paraphrased sentences determined through a trained network model to the device 900.

In an embodiment of the disclosure, the server 100 may transmit a plurality of paraphrased sentences to the device 900 and recommend one or more sentences from among the source sentence and the plurality of paraphrased sentences to the user. The device 900 may determine a recommended sentence and display the recommended sentence by emphasis-marking the recommended sentence. For example, the recommended sentence may be emphasis-marked by shading, displaying an additional shape, or highlighting, but the disclosure is not limited thereto. To determine the recommended sentence, the server may consider a similarity level with the source sentence, the context of the source sentence, the type of the source sentence, and frequencies of similar sentences, but the disclosure is not limited thereto,

For example, when a trained network model considers the context of a source sentence to determine a recommended sentence, the trained network model may recognize that the sentence 110 has the context of an academic article and determine the sentence 2a 22, which has the context of an academic article as compared to sentences 2b and 2c 24 and 26 having the contexts of normal articles, as the recommended sentence.

Also, when the trained network model considers the structure of the source sentence to determine a recommended sentence, the trained network model may recognize that the sentence 110 is written as an active sentence and determine the sentence 2b 24, which is an active sentence, as the recommended sentence, rather than the sentence 2a 22, which is a passive sentence.

Also, when the trained network model considers the frequencies of similar sentences, the server or the trained network model may determine the sentence 2b 24 including the word “tourist” as the recommended sentence, rather than the sentence 2c 26 including the word “people”.

The device 900 may be a smart phone, a tablet PC, a PC, a smart TV, a mobile phone, a personal digital assistant (PDA), a laptop computer, a media player, a micro server, a global positioning system (GPS) device, an e-book device, a digital broadcasting terminal, a navigation device, a kiosk, an MP3 player, a digital camera, a home appliance, and other mobile or non-mobile computing devices, but is not limited thereto. Also, the device 900 may be a wearable device, such as a wristwatch, an eyeglass, a hair band, and a ring, having a communication function and a data processing function.

FIG. 9B illustrates a diagram showing an example of a device for outputting a plurality of paraphrased sentences written in a language different from a source sentence, according to an embodiment of the disclosure.

In an embodiment of the disclosure, a user of the device 900 may communicate with a server via a network to obtain a plurality of paraphrased sentences written in a language different from a source sentence. For example, as the user inputs a source sentence to the device 900, the device 900 may transmit a request for generating a plurality of paraphrased sentences written in a language different from the source sentence to the server via a network. The server may transmit a plurality of paraphrased sentences determined through a trained network model to the device 900.

In an embodiment of the disclosure, the server 100 may transmit a plurality of paraphrased sentences to the device 900 and recommend one or more sentences from among the source sentence and the plurality of paraphrased sentences to the user. The device 900 may emphasis-mark and display the recommended sentence on a display device. For example, the recommended sentence may be emphasis-marked by shading, displaying an additional shape, or highlighting, but the disclosure is not limited thereto. To determine the recommended sentence, the server may consider a similarity level with the source sentence, the context of the source sentence, the type of the source sentence, and frequencies of similar sentences, but the disclosure is not limited thereto,

For example, through the device 900, a user may obtain a plurality of paraphrased sentences written in English which is translation of a source sentence “ [symbol] [symbol] .” (hereinafter referred to as a sentence 330) written in Korean when it is necessary to repeatedly send e-mails or to repeatedly show gratitude. The user may use different sentences each time the user writes an email using the obtained plurality of paraphrased sentences. Unlike the existing technology, it is possible to extract translated sentences in various forms to enable a user to use a natural foreign language.

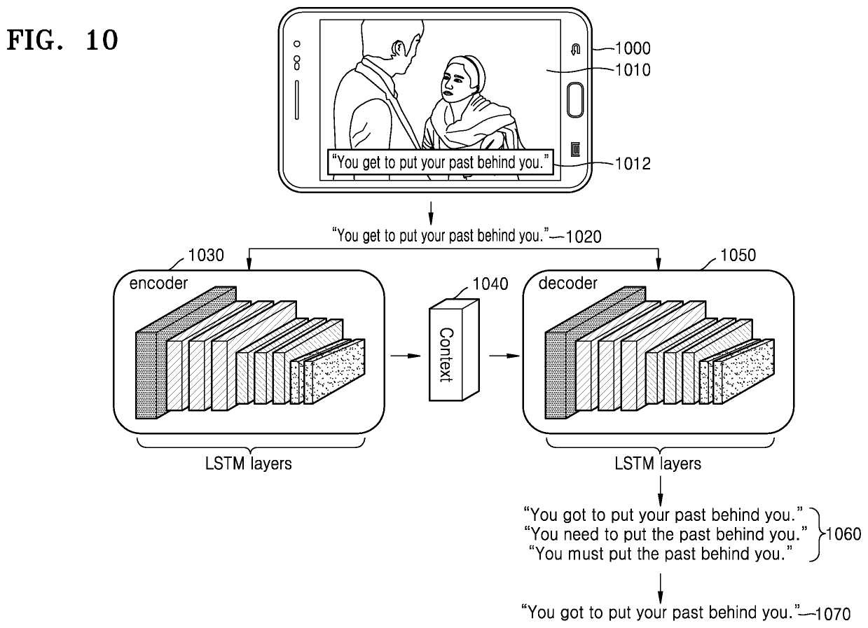

FIG. 10 illustrates a diagram showing a method by which a server extracts texts in an image from a device and determines a plurality of paraphrased sentences and a recommended sentence in real time, according to an embodiment of the disclosure.

According to an embodiment of the disclosure, a server including one or more processors may receive an image 1010 including a text 1012 from a device 1000. The image 1010 may include an image in a moving image or a static image. The server may obtain a text 1020 by performing an character recognition process, and the optical character recognition process may be an OCR (Optical Character Recognition), but is not limited thereto.

According to an embodiment of the disclosure, the server may determine a plurality of paraphrased sentences 1060 for the obtained text 1020 by using a trained network model. The trained network model may include an encoder neural network 1030 and a decoder neural network 1050, and the encoder neural network 1030 and the decoder neural network 1050 may include LSTM layers. The encoder neural network 1030 and the decoder neural network 1050 may receive the obtained text 1020, and the encoder neural network 1030 may output a context vector 1040 corresponding to the text 1020. The decoder neural network 1050 may receive the output context vector 1040 and determine the plurality of paraphrased sentences 1060.

According to an embodiment of the disclosure, the server may determine a recommended sentence 1070 from among the plurality of determined paraphrased sentences 1060. The server may consider similarity with the obtained text 1020, relationships with other texts in the image, the type of text, and frequencies of similar sentences to determine the recommended sentence 1070, but the method by which the server determines the recommended sentence 1070 is not limited thereto. For example, referring to FIG. 10, the server may extract the text 1012 in the image 1010 and determine a sentence obtained by correcting an error of the obtained text 1012 as the recommended sentence 1070. Therefore, in an embodiment of the disclosure, the disclosure may be used for typo correction of subtitles.

For example, the server may extract a sentence “You get put your past behind you.” (hereinafter referred to as a sentence 4). Considering the context, the sentence 4 corresponds to a sentence in which a present tense word ‘get’ is erroneously used instead of a past tense word ‘got’. By using the sentence 4 as an input, the server may use a trained network model to determine a plurality of paraphrased sentences, that is, a sentence “You got to put your past behind you.” (hereinafter referred to as a sentence 5a), a sentence “You need to put the past behind you.” (hereinafter referred to as a sentence 5b), and a sentence “You must put your past behind you.” (hereinafter referred to as a sentence 5c). Furthermore, the server may determine the sentence 5a as a recommended sentence.

According to an embodiment of the disclosure, the plurality of paraphrased sentences 1060 corresponding to the obtained text 1020 may include at least one of a plurality of paraphrased sentences written in the same language as the text 1020 and a paraphrased sentences written in a language different from the text 1020.

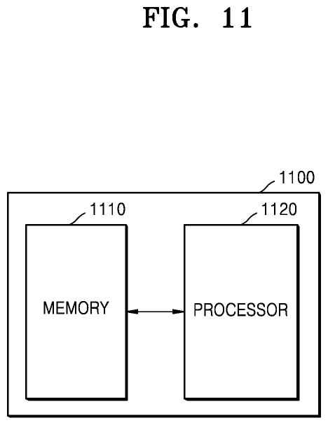

FIG. 11 illustrates a diagram showing a configuration of a server according to an embodiment of the disclosure.

Referring to FIG. 11, a server 1100 may include a memory 1110 and a processor 1120.

The memory 1110 may store various data, programs, or applications for driving and controlling the server 1100. A program stored in the memory 1110 may include one or more instructions. A program (one or more instructions) or an application stored in the memory 1110 may be executed by the processor 1120.

The memory 1110 according to an embodiment of the disclosure may include one or more instructions constituting a neural network. Also, the memory 1110 may include one or more instructions for controlling the neural network. The neural network may include a plurality of layers including one or more instructions for identifying and/or determining a plurality of words constituting a source sentence from the source sentence, a plurality of layers including one or more instructions for determining one or more paraphrased words corresponding to each of the words identified from the source sentence, and a plurality of layers including one or more instructions for determining a plurality of paraphrased sentences with the one or more determined paraphrased words.

The processor 1120 may execute an operating system (OS) and various applications stored in the memory 1110. The processor 1120 may include one or more processors including a single core, dual core, triple core, quad core, and cores of multiples thereof. For example, the processor 1120 may be implemented as a main processor (not shown) and a sub-processor (not shown) that operates in a sleep mode.

The processor 1120 according to an embodiment of the disclosure may obtain a source sentence stored in the memory 1110. Also, the processor 1120 may receive a source sentence from a device through a communicator (not shown). The processor 1120 may identify a plurality of words in a source sentence by using instructions constituting a neural network stored in the memory 1110 and determine one or more paraphrased words corresponding to each of the plurality of words. In this regard, the processor 1120 may determine a plurality of paraphrased sentences corresponding to the source sentence.

Meanwhile, the processor 1120 may perform operations as described above with reference to FIGS. 1 through 10, that is, identification of the plurality of words in the source sentence, determination of one or more paraphrased words for each of the plurality of identified words, and determination of a plurality of paraphrased sentences by using the one or more determined paraphrased words. Also, the processor 1120 may control the memory 1110 to store the plurality of determined paraphrased sentences.

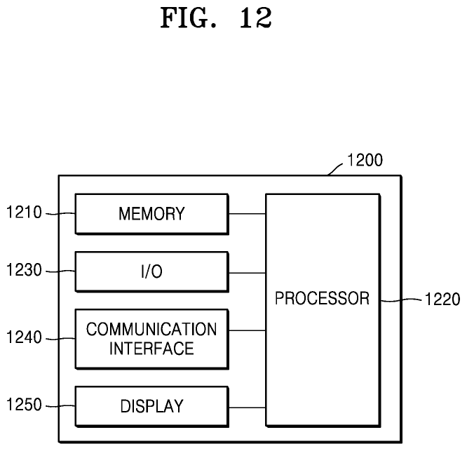

FIG. 12 illustrates a block diagram showing a structure of a device according to an embodiment of the disclosure.

Referring to FIG. 12, a device 1200 may include a memory 1210, a processor 1220, an I/O unit 1230, a communication interface 1240, and a display 1250. However, not all of the illustrated components are necessary components. The device 1200 may be implemented by more components than the illustrated components, and the device 1200 may also be implemented by fewer components. In another example, the device 1200 may include a plurality of processors.

The memory 1210 may store various data, programs, or applications for driving and controlling the device 1200. A program stored in the memory 1210 may include one or more instructions. A program (one or more instructions) or an application stored in the memory 1210 may be executed by the processor 1220.

The memory 1210 according to an embodiment of the disclosure may include one or more instructions constituting a neural network. Also, the memory 1210 may include one or more instructions for controlling the neural network. The neural network may include a plurality of layers including one or more instructions for identifying and/or determining a plurality of words constituting a source sentence from the source sentence, a plurality of layers including one or more instructions for determining one or more paraphrased words corresponding to each of the words identified from the source sentence, and a plurality of layers including one or more instructions for determining a plurality of paraphrased sentences with the one or more determined paraphrased words.

The processor 1220 may execute an operating system (OS) and various applications stored in the memory 1210. The processor 1220 may include one or more processors including a single core, dual core, triple core, quad core, and cores of multiples thereof. For example, the processor 1220 may be implemented as a main processor (not shown) and a sub-processor (not shown) that operates in a sleep mode.

The processor 1220 according to an embodiment of the disclosure may obtain a source sentence. For example, the processor 1120 according to an embodiment of the disclosure may obtain a source sentence stored in the memory 1210. Also, the processor 1220 may receive a source sentence from an external server (e.g., a social media server, a cloud server, a content providing server, etc.) through the communication interface 1240.

According to an embodiment of the disclosure, the processor 1220 may identify a plurality of words in a source sentence, determine one or more paraphrased words corresponding to each of the plurality of words, and determine a plurality of paraphrased sentences by using the one or more paraphrased words, by using instructions constituting the neural network stored in the memory 1210. In this regard, the processor 1220 may determine a plurality of paraphrased sentences corresponding to the source sentence.

Meanwhile, the method by which the processor 1120 identifies a plurality of words in a source sentence, determines one or more paraphrased words for each of the plurality of identified words, and determines a plurality of paraphrased sentences by using the one or more determined paraphrased words may correspond to operations S210 to S240 described above with reference to FIG. 2. Also, the processor 1220 may control the memory 1210 to store the plurality of determined paraphrased sentences.

The communication interface 1240 may communicate with another device (not shown) or the server 100. The communication interface may communicate with various types of external devices according to various types of communication schemes. The communication interface may include at least one of a Wi-Fi chip, a Bluetooth chip, a wireless communication chip, and a near field communication (NFC) chip. The Wi-Fi chip and the Bluetooth chip may perform communications via Wi-Fi and Bluetooth, respectively.

In the case of using a Wi-Fi chip or a Bluetooth chip, various connection information, such as a SSID and a session key, may be transmitted and received first, a communication may be established by using the same, and various information may be transmitted and received. The wireless communication chip refers to a chip that performs communications according to various communication standards, such as IEEE, Zigbee, 3rd Generation (3G), 3rd Generation Partnership Project (3GPP), Long Term Evolution (LTE), etc. The NFC chip refers to a chip operating in an NFC scheme using a 13.56 MHz band from among various RF-ID frequency bands, e.g., 135 kHz, 13.56 MHz, 433 MHz, 860 to 960 MHz, and 2.45 GHz.

The display 1250 may display information processed by the processor 1220 under the control of the processor 1220. Also, the display 1250 may display all data information received from the server 100, the data information including all UI information operated on the device 1200. According to an embodiment of the disclosure, the display 1250 may output a plurality of paraphrased sentences and a recommended sentence determined by the processor 1220 on a screen of the device 1200.

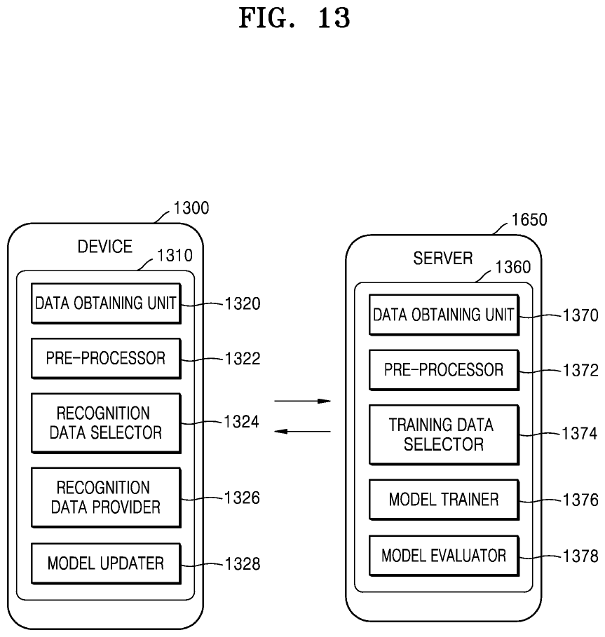

FIG. 13 illustrates a diagram showing an example in which a device 1300 and a server 1350 learn and recognize data by operating in conjunction with each other, according to an embodiment of the disclosure.

Referring to FIG. 13, the server 1350 may learn criteria for identifying a plurality of words included in a source sentence and one or more paraphrased words thereof. For example, the server 1350 may learn attributes of a sentence used to identify a plurality of words and one or more paraphrased words thereof and attributes of the words. Also, the server 1350 may learn attributes of a sentence that serves as a reference for determining a plurality of paraphrased sentences corresponding to the source sentence. The server 1350 may learn criteria for identifying words in a sentence or determining paraphrased sentences by obtaining data to be used for learning and applying the obtained data to a data recognition model to be described below.

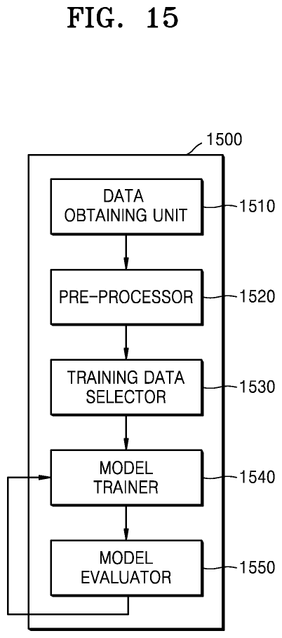

Meanwhile, a data obtaining unit 1370, a pre-processor 1372, a training data selector 1374, a model trainer 1376, and a model evaluator 1378 of the server 1350 may perform functions of a data obtaining unit 1510, a pre-processor 1520, a training data selector 1530, a model trainer 1540, and a model evaluator 1550 described below with reference to FIG. 15, respectively.

The data obtaining unit 1370 may obtain data necessary for identifying a plurality of words in a source sentence or determining paraphrased words thereof. The pre-processor 1372 may pre-process the obtained data, such that the obtained data may be used for learning for identification of a plurality of words in the source sentence or determination of paraphrased words thereof. The training data selector 1374 may select data for training from among the pre-processed data. The selected data may be provided to the model trainer 1376.

The model trainer 1376 may learn criteria for using which of attributes of an input source sentence or attributes of the context to determine a plurality of words or paraphrased words thereof and criteria for determining a plurality of paraphrased sentences by using attributes of the source sentence or attributes of the context. The model trainer 1376 may learn criteria for identification of objects or determination of correction filters by obtaining data to be used for training and applying the obtained data to a data recognition model which will be described below.

The model evaluator 1378 may input evaluation data to a data recognition model and, when a recognition result output from the evaluation data does not satisfy predetermined criteria, may instruct the model trainer 1376 to do learning again.

The server 1350 may provide a generated recognition model to the device 1300. In this case, the device 1300 may identify a plurality of words or determine one or more paraphrased words thereof and a plurality of paraphrased sentences by using a received recognition model.

Meanwhile, according to another embodiment of the disclosure, the server 1350 may apply data received from the device 1300 to a generated data recognition model, thereby identifying a plurality of words or determining one or more paraphrased words thereof and a plurality of paraphrased sentences. For example, the device 1300 may transmit data selected by a recognition data selector 1324 to server 1350, and the server 1350 may apply the selected data to a recognition model to identify a plurality of words or determine one or more paraphrased words thereof and a plurality of paraphrased sentences.

Also, the server 1350 may provide information regarding a plurality of words identified by the server 1350, one or more paraphrased words thereof determined by the server 1350, and a plurality of paraphrased sentences determined by the server 1350 to the device 1300. Therefore, the device 1300 may receive information regarding a plurality of words, one or more paraphrased words thereof, and a plurality of paraphrased sentences from the server 1350.

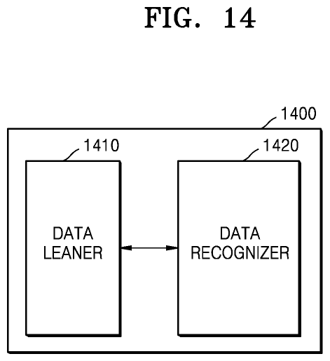

FIG. 14 illustrates a diagram for describing a processor of a server or a device, according to an embodiment of the disclosure.

Referring to FIG. 14, a processor 1400 according to some embodiments of the disclosure may include a data learner 1410 and a data recognizer 1420.

The data learner 1410 may learn criteria for obtaining a plurality of paraphrased sentences corresponding to a source sentence. The data learner 1410 may learn criteria for which data is to be used to obtain a plurality of paraphrased sentences and criteria for how to process a source sentence by using data. The data learner 1410 may learn criteria for obtaining a plurality of paraphrased sentences corresponding to a source sentence by obtaining data to be used for learning and applying the obtained data to a data recognition model to be described below.

The data recognizer 1420 may determine a source sentence based on data. The data recognizer 1420 may obtain a plurality of paraphrased sentences corresponding to the source sentence by using a learned data recognition model. The data recognizer 1420 may obtain certain data according to pre-set criteria based on training and utilize a data determination model by using the obtained data as input values, thereby obtaining a plurality of paraphrased sentences corresponding to the source sentence based on certain data. Furthermore, a result value output by the data determination model by using the obtained data as input values may be used to modify and refine the data determination model.

At least one of the data learner 1410 and the data recognizer 1420 may be fabricated in the form of at least one hardware chip and mounted on an electronic device. For example, at least one of the data learner 1410 and the data recognizer 1420 may be fabricated in the form of a dedicated hardware chip for artificial intelligence (AI) or may be fabricated as a part of a known general-purpose processor (e.g., a CPU or an application processor) or a graphics-only processor (e.g., a GPU) and may be mounted on the various electronic devices as described above.

In this case, the data learner 1410 and the data recognizer 1420 may be mounted on one electronic device or may be mounted respectively on separate electronic devices. For example, one of the data learner 1410 and the data recognizer 1420 may be included in an electronic device, and the other one may be included in a server. Also, the data learner 1410 and the data recognizer 1420 may provide information about a model established by the data learner 1410 to the data recognizer 1420 via a wire or a wireless network or data input to the data recognizer 1420 may be provided to the data learner 1410 as additional training data.

Meanwhile, at least one of the data learner 1410 and the data recognizer 1420 may be implemented as a software module. When at least one of the data learner 1410 and the data recognizer 1420 is implemented as a software module (or a program module including instructions), the software module may be stored in a non-transitory computer-readable medium. Furthermore, in this case, at least one software module may be provided by an operating system (OS) or by a certain application. Alternatively, some of the at least one software module may be provided by the OS, and the other software modules may be provided by a certain application.

FIG. 15 illustrates a block diagram showing a data learner 1500 according to an embodiment of the disclosure.

Referring to FIG. 15, the data learner 1500 according to an embodiment of the disclosure may include a data obtaining unit 1510, a pre-processor 1520, a training data selector 1530, a model trainer 1540, and a model evaluator 1550. However, this is merely an embodiment of the disclosure. The data learner 1500 may be configured with fewer components than the above-described components, or components other than the above-described components may be additionally included in the data learner 1500.

The data obtaining unit 1510 may obtain data necessary for identifying a plurality of words in a source sentence or determining one or more paraphrased words thereof and a plurality of paraphrased sentences. For example, the data obtaining unit 1510 may obtain data stored in a memory of a device. In another example, the data obtaining unit 1510 may obtain data from an external server, such as a social media server, a cloud server, or a content providing server.

The pre-processor 1520 may pre-process the obtained data, such that the obtained data may be used for learning for identification of a plurality of words in the source sentence or determination of one or more paraphrased words thereof and a plurality of paraphrased sentences. According to an embodiment of the disclosure, the pre-processor 1520 may perform at least one of the tokenizing process and the normalization process described above with reference to FIG. 5. The pre-processor 1520 may process the obtained data to a pre-set format, such that the model trainer 1540 to be described below may use the obtained data for learning for identification of a plurality of words or determination of one or more paraphrased words thereof and a plurality of paraphrased sentences.

The training data selector 1530 may select data for training from among the pre-processed data. The selected data may be provided to the model trainer 1540. The training data selector 1530 may select data for training from among pre-processed data according to pre-set selection criteria for identifying a plurality of words or determining one or more paraphrased words thereof and a plurality of paraphrased sentences. According to an embodiment of the disclosure, a word needed for training may be selected, and beam search may be used in a method of selecting a word needed for training. Also, the training data selector 1530 may select data according to pre-set selection criteria based on training by the model trainer 1540 to be described below.

For example, based on pre-processed data, the training data selector 1530 may determine types of words, forms of words, or sentence structures with relatively high relevance (e.g., a high density of probability distribution) with a category corresponding to a source sentence as data to be included in criteria for determining paraphrased words.

The model trainer 1540 may learn, such that a data recognition model has criteria for how to make determinations for identification of a plurality of words or determinations of one or more paraphrased words thereof and a plurality of paraphrased sentences based on training data. Also, the model trainer 1540 may learn criteria for selecting training data for identification of a plurality of words or determinations of one or more paraphrased words thereof and a plurality of paraphrased sentences.

A data recognition model may be constructed in consideration of the field of application of the data recognition model, the purpose of learning, or the computing efficiency of a device. The data recognition model may be, for example, a model based on a neural network. For example, a model like a deep neural network (DNN), a recurrent neural network (RNN), and a bidirectional recurrent deep neural network (BRDNN) may be used as the data recognition model, but is not limited thereto.

According to various embodiments of the disclosure, when there are a plurality of pre-built data recognition models, the model trainer 1540 may determine a data recognition model to learn a data recognition model with basic training data highly related to input training data as a data recognition model to learn. In this case, the basic training data may be categorized in advance according to types of data, and data recognition models may be built in advance for respective types of data. For example, the basic training data may be categorized in advance based on various criteria, such as regions where training data is generated, times at which the training data is generated, sizes of the training data, genres of the training data, creators of the training data, and types of objects in the training data.

Also, the model trainer 1540 may train a data recognition model by using, for example, a training algorithm including error back-propagation or gradient descent.

Also, the model trainer 1540 may train the data recognition model, for example, through supervised learning using training data for learning criteria as an input. The model trainer 2940 may also autonomously learn data needed for identification of a plurality of words or determination of one or more paraphrased words thereof and a plurality of paraphrased sentences without separate supervision, thereby training a data recognition model through unsupervised learning for discovering criteria for identification of a plurality of words or determination of one or more paraphrased words thereof and a plurality of paraphrased sentences.

Also, for example, the model trainer 1540 may train a data recognition model through reinforcement learning using a feedback on whether a result of identifying a plurality of words or a result of determining one or more paraphrased words thereof and a plurality of paraphrased sentence based on learning is correct.

Also, when the data recognition model is trained, the model trainer 1540 may store the trained data recognition model. In this case, the model trainer 1540 may store the trained data recognition model in a memory of an electronic device including the data learner 1500. Alternatively, the model trainer 1540 may store the trained data recognition model in a memory of an electronic device including a data recognizer 1600 to be described below. Also, the model trainer 1540 may store the trained data recognition model in a memory of a server connected to an electronic device through a wire or a wireless network.

In this case, the memory in which the trained data recognition model is stored may store, for example, instructions or data related to at least one other component of the electronic device. The memory may also store software and/or programs. The program may include, for example, a kernel, middleware, an application programming interface (API) and/or an application program (or “application”), or the like.

The model evaluator 1550 may input evaluation data to a data recognition model and, when a recognition result output from the evaluation data does not satisfy predetermined criteria, may instruct the model trainer 1540 to do learning again. In this case, the evaluation data may be pre-set data for evaluating the data recognition model. Here, the evaluation data may include a similarity between a plurality of words identified based on the data recognition model and a source sentence.

For example, the model evaluator 1550 may determine that a predetermined criterion is not satisfied when the number or a ratio of pieces of evaluation data corresponding to incorrect recognition results from among recognition results of a trained data recognition model regarding the evaluation data exceeds a pre-set critical value. For example, when the predetermined criterion is defined as a ratio of 2% and a trained data recognition model outputs incorrect recognition results for more than 20 out of total 1000 pieces of evaluation data, the model evaluator 1550 may determine that the trained data recognition model is not suitable.

Meanwhile, at least one of the data obtaining unit 1510, the pre-processor 1520, the training data selector 1530, the model trainer 1540, and the model evaluator 1550 in the data learner 1500 may be fabricated in the form of at least one hardware chip and may be mounted on an electronic device. For example, at least one of the data obtaining unit 1510, the pre-processor 1520, the training data selector 1530, the model trainer 1540, and the model evaluator 1550 may be fabricated in the form of a dedicated hardware chip for artificial intelligence (AI) or may be fabricated as a part of a known general-purpose processor (e.g., a CPU or an application processor) or a graphics-only processor (e.g., a GPU) and may be mounted on the various electronic devices as described above.

Also, the data obtaining unit 1510, the pre-processor 1520, the training data selector 1530, the model trainer 1540, and the model evaluator 1550 may be mounted on one electronic device or may be mounted respectively on separate electronic devices. For example, some of the data obtaining unit 1510, the pre-processor 1520, the training data selector 1530, the model trainer 1540, and the model evaluator 1550 may be included in an electronic device, and the others may be included in a server.

Also, at least one of the data obtaining unit 1510, the pre-processor 1520, the training data selector 1530, the model trainer 1540, and the model evaluator 1550 may be implemented as a software module. When at least one of the data obtaining unit 1510, the pre-processor 1520, the training data selector 1530, the model trainer 1540, and the model evaluator 1550 is implemented as a software module (or a program module including instructions), the software module may be stored in a non-transitory computer-readable medium. Furthermore, in this case, at least one software module may be provided by an operating system (OS) or by a certain application. Alternatively, some of the at least one software module may be provided by the OS, and the other software modules may be provided by a certain application.

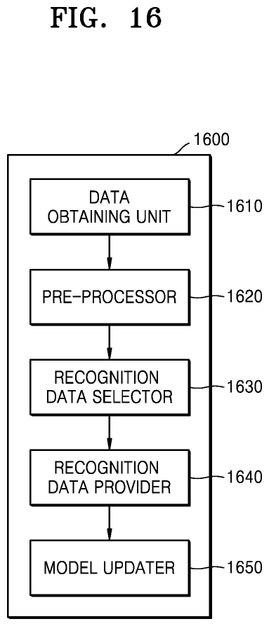

FIG. 16 illustrates a block diagram showing a data recognizer according to an embodiment of the disclosure.

Referring to FIG. 16, a data recognizer 1600 according to an embodiment of the disclosure may include a data obtaining unit 1610, a pre-processor 1620, a recognition data selector 1630, a recognition result provider 1640, and a model updater 1650. However, this is merely an embodiment of the disclosure, and the data recognizer 1600 may include some of the above-described components or may further include other components in addition to the above-described components.

The data obtaining unit 1510 may obtain data necessary for identifying a plurality of words in a source sentence or determining one or more paraphrased words thereof and a plurality of paraphrased sentences, and the pre-processor 1620 may pre-process the obtained data, such that the obtained data may be used for learning for identification of a plurality of words in the source sentence or determination of one or more paraphrased words thereof and a plurality of paraphrased sentences. The pre-processor 1620 may pre-process the obtained data, such that the recognition result provider 1640 may user the obtained data for identification of a plurality of words in the source sentence or determination of one or more paraphrased words thereof and a plurality of paraphrased sentences.

The recognition data selector 1630 may select recognition data necessary for identifying a plurality of words or determining one or more paraphrased words thereof and a plurality of paraphrased sentences from among the pre-processed data. The selected recognition data may be provided to the recognition result provider 1640. The recognition data selector 1630 may select some or all of pre-processed recognition data according to pre-set selection criteria for identifying a plurality of words or determining one or more paraphrased words thereof and a plurality of paraphrased sentences.

The recognition result provider 1640 may apply the selected data to a data recognition model to determine the situation. The recognition result provider 1640 may provide a recognition result according to the purpose of data recognition. The recognition result provider 1640 may apply the selected recognition data to the data recognition model by using the recognition data selected by the recognition result provider 1630 as an input value. Also, a recognition result may be determined by a data recognition model.

The model updater 1650 may control a data recognition model to be renewed based on a evaluation of a recognition result provided by the recognition result provider 1640. For example, the model updater 1650 may control the model trainer 1540 to renew a data recognition model by providing the model trainer 1540 with a recognition result provided by the recognition result provider 1640.

Meanwhile, at least one of the data obtaining unit 1610, the pre-processor 16t20, the recognition data selector 1630, the recognition result provider 1640, and the model updater 1650 in the data recognizer 1600 may be fabricated in the form of at least one hardware chip and may be mounted on an electronic device. For example, at least one of the data obtaining unit 1610, the pre-processor 16t20, the recognition data selector 1630, the recognition result provider 1640, and the model updater 1650 may be fabricated in the form of a dedicated hardware chip for artificial intelligence (AI) or may be fabricated as a part of a known general-purpose processor (e.g., a CPU or an application processor) or a graphics-only processor (e.g., a GPU) and may be mounted on the various electronic devices as described above.

Also, the data obtaining unit 1610, the pre-processor 16t20, the recognition data selector 1630, the recognition result provider 1640, and the model updater 1650 may be mounted on one electronic device or may be mounted respectively on separate electronic devices. For example, some of the data obtaining unit 1610, the pre-processor 16t20, the recognition data selector 1630, the recognition result provider 1640, and the model updater 1650 may be included in an electronic device, and the others may be included in a server.

Also, at least one of the data obtaining unit 1610, the pre-processor 16t20, the recognition data selector 1630, the recognition result provider 1640, and the model updater 1650 may be implemented as a software module. When at least one of the data obtaining unit 1610, the pre-processor 16t20, the recognition data selector 1630, the recognition result provider 1640, and the model updater 1650 is implemented as a software module (or a program module including instructions), the software module may be stored in a non-transitory computer-readable medium. Furthermore, in this case, at least one software module may be provided by an operating system (OS) or by a certain application. Alternatively, some of the at least one software module may be provided by the OS, and the other software modules may be provided by a certain application.

One or more embodiments of the disclosure may be implemented by a computer-readable recording medium including computer-executable instructions such as a program module executed by a computer. The computer-readable recording medium may be an arbitrary available medium accessible by a computer, and examples thereof include all volatile media (e.g., RAM) and non-volatile media (e.g., ROM) and separable and non-separable media. Further, examples of the computer-readable recording medium may include a computer storage medium. Examples of the computer storage medium include all volatile and non-volatile media and separable and non-separable media, which have been implemented by an arbitrary method or technology, for storing information such as computer-readable instructions, data structures, program modules, and other data.

The embodiments of the disclosure may be implemented as software programs that include instructions stored in a computer-readable storage medium.

The computer is a device capable of invoking stored instructions from a storage medium and operating according to the embodiments of the disclosure according to the invoked instructions and may include an electronic device according to the embodiments of the disclosure.

The computer readable storage medium may be provided in the form of a non-transitory storage medium. Here, the term ‘non-temporary’ means that a storage medium does not include a signal and is tangible, regardless whether data is stored semi-permanently or temporarily on the storage medium.

Also, a control method according to the embodiments of the disclosure may be provided included in a computer program product. A computer program product may be traded between a seller and a buyer as a product.

The computer program product may include a software program and a computer readable storage medium storing the software program. For example, the computer program product may include a product (e.g., a downloadable app) in the form of a software program that is distributed electronically through a device manufacturer or an electronic market (e.g., Google Play Store, App Store). For electronic distribution, at least a portion of the software program may be stored in a storage medium or temporarily generated. In this case, the storage medium may be a storage medium of a server of a manufacturer, a server of an electronic market, or a relay server that temporarily stores the software program.

The computer program product may include a storage medium of a server or a storage medium of a device in a system including the server and the device. Alternatively, when there is a third device (e.g., a smart phone) that is in communication with the server or the device, the computer program product may include a storage medium of the third device. Alternatively, the computer program product may include the software program itself transmitted from the server to the device or the third device or transmitted from the third device to the device.

In this case, one of the server, the device, and the third device may execute the computer program product to perform the method according to the embodiments of the disclosure. Alternatively, two or more of the server, the device, and the third device may execute a computer program product and perform the method according to the embodiments of the disclosure in a distributed fashion.

For example, the server (e.g., a cloud server or an AI server, etc.) may execute a computer program product stored on the server to control the device in communication with the server to perform the method according to the embodiments of the disclosure.

In another example, the third device may execute a computer program product to control the device in communication with the third device to perform the method according to the embodiment of the disclosure. When the third device executes a computer program product, the third device may download the computer program product from the server and execute the downloaded computer program product. Alternatively, the third device may execute a computer program product provided in a pre-loaded state to perform the method according to the embodiments of the disclosure.

Also, in this specification, a “unit” may be a hardware component, such as a processor or a circuit, and/or a software component executed by a hardware component like a processor.

According to embodiments of the disclosure, the time and cost for obtaining data for training a trained network model may be reduced.

Also, according to embodiments of the disclosure, the language understanding of a virtual assistance may be improved, thereby enabling more accurate translation and command understanding for languages with insufficient resources.

Other features and advantages of the disclosure will be apparent from the following detailed description and the accompanying drawings.

It will be understood by one of ordinary skill in the art that various changes in form and details may be made therein without departing from the spirit and scope of the disclosure as defined by the following claims. It is therefore to be understood that the above-described embodiments of the disclosure are merely illustrative in all aspects and not restrictive. For example, each component described as a single entity may be distributed and implemented, and components described as being distributed may also be implemented in a combined form.

Therefore, the scope of the disclosure is defined not by the detailed description of the disclosure but by the appended claims, and all differences within the scope will be construed as being included in the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of processing a language based on a trained network model, the method comprising:
obtaining a source sentence;
obtaining a plurality of words constituting the source sentence;
determining a plurality of paraphrased sentences including paraphrased words for each of the plurality of words constituting the source sentence and levels of similarity between the plurality of paraphrased sentences and the source sentence; and
obtaining a pre-set number of paraphrased sentences from among the plurality of paraphrased sentences based on the similarity levels.

2. The method of claim 1, further comprising receiving an image,
wherein the obtaining of the source sentence comprises:
recognizing a text included in the received image; and
obtaining the source sentence from the recognized text.

3. The method of claim 1, wherein:
the trained network model comprises a sequence-to-sequence model that comprises an encoder and a decoder to which context vectors are applied as inputs and outputs, respectively, and
the similarity levels are determined based on a probability that the paraphrased words determined by the decoder and the words of the source sentence coincide with each other.

4. The method of claim 1, further comprising performing at least one of a tokenizing process and a normalizing process with respect to the plurality of words constituting the source sentence.

5. The method of claim 1, wherein obtaining the pre-set number of paraphrased sentences comprises:
determining ranks of the plurality of paraphrased sentences based on the similarity levels, respective numbers of words constituting the plurality of paraphrased sentences, and respective lengths of the plurality of paraphrased sentences; and
selecting the pre-set number of paraphrased sentences from among the plurality of paraphrased sentences based on determined ranks.

6. The method of claim 5, wherein the ranks of the plurality of paraphrased sentences are determined by using beam search.

7. The method of claim 1, wherein the plurality of paraphrased sentences comprise paraphrased sentences written in a language different from the obtained source sentence.

8. The method of claim 7, wherein the plurality of paraphrased sentences further comprise paraphrased sentences written in the same language as the source sentence.

9. The method of claim 1, further comprising determining a recommended sentence from among the plurality of paraphrased sentences.

10. A device for processing a language based on a trained network model, the device comprising:
a memory configured to store one or more instructions; and
at least one processor configured to execute the one or more instructions stored in the memory, wherein the processor is configured to:
obtain a source sentence,
to obtain a plurality of words constituting the source sentence,
to determine a plurality of paraphrased sentences including paraphrased words for each of the plurality of words constituting the source sentence and levels of similarity between the plurality of paraphrased sentences and the source sentence, and
to obtain a pre-set number of paraphrased sentences from among the plurality of paraphrased sentences based on the similarity levels.

11. The device of claim 10, wherein the at least one processor is further configured to:
receive an image,
recognize a text included in the received image, and
obtain the source sentence from the recognized text.

12. The device of claim 10, wherein:
the trained network model comprises a sequence-to-sequence model that comprises an encoder and a decoder to which context vectors are applied as an input and an output, respectively, and
the similarity levels are determined based on a probability that paraphrased words determined by the decoder and the words of the source sentence coincide with each other.

13. The device of claim 10, wherein the at least one processor is further configured to perform at least one of a tokenizing process and a normalizing process with respect to the plurality of words constituting the source sentence.

14. The device of claim 10, wherein the at least one processor is further configured to:
determine ranks of the plurality of paraphrased sentences based on the similarity levels, respective numbers of words constituting the plurality of paraphrased sentences, and respective lengths of the plurality of paraphrased sentences, and
select a pre-set number of paraphrased sentences from among the plurality of paraphrased sentences based on determined ranks.

15. The device of claim 14, wherein the at least one processor is further configured to determine the ranks of the plurality of paraphrased sentences by using beam search.

16. The device of claim 10, wherein the plurality of paraphrased sentences comprise paraphrased sentences written in a language different from the obtained source sentence.

17. The device of claim 16, wherein the plurality of paraphrased sentences further comprise a paraphrased sentences written in the same language as the source sentence.

18. The device of claim 10, wherein the at least one processor is further configured to determine a recommended sentence from among the plurality of paraphrased sentences.

19. A computer program product embodied on a non-transitory computer-readable storage medium and comprising instructions that, when executed by at least one processor of a computing device, cause the at least one processor to:
obtain a source sentence;
obtain a plurality of words constituting the source sentence;
determine a plurality of paraphrased sentences including paraphrased words for each of the plurality of words constituting the source sentence and levels of similarity between the plurality of paraphrased sentences and the source sentence; and
obtain a pre-set number of paraphrased sentences from among the plurality of paraphrased sentences based on the similarity levels.

20. The computer program product of claim 19, further comprising instructions that, when executed by the at least one processor cause the at least one processor to:
determine ranks of the plurality of paraphrased sentences based on the similarity levels, respective numbers of words constituting the plurality of paraphrased sentences, and respective lengths of the plurality of paraphrased sentences; and
select the pre-set number of paraphrased sentences from among the plurality of paraphrased sentences based on determined ranks.
